(19) United States
(12) Patent Application Publication
(10) Pub. No.: US 2005/0171990 A1
(43) Pub. Date: Aug. 4, 2005

(54) Floating point intensive reconfigurable computing system for iterative applications

(76) Inventors: Benjamin Bishop, Bloomsburg, PA (US); Thomas P. Kclliher, Baltimore, MD (US); Shrirang Madhav Yardi, Blacksburg, VA (US)

Correspondence Address: Womble Carlyle Sandridge & Rice, PLLC, P.O. Box 7037, Atlanta, GA, 30357-0037, US

(21) Appl. No.: 10/862,269

(22) Filed: Jun. 7, 2004

Related U.S. Application Data
(63) Continuation-in-part of application No. PCT/US02/38645, filed on Dec. 6, 2002.
(60) Provisional application No. 60/338,347, filed on Dec. 6, 2001.
(60) Provisional application No. 60/511,538, filed on Oct. 15, 2003.

(51) Int. Cl. G06F 15/00

(52) U.S. Cl. 708/501

(57) ABSTRACT

A reconfigurable computing system for accelerating execution of floating point intensive iterative applications. The reconfigurable computing system includes a plurality of interconnected processing elements mounted on a printed circuit board, a host processing system for displaying real-time outputs of the floating point calculations performed by the processing elements, and an interface for connecting the processing elements to the host system. Each of the interconnected processing elements includes a floating point functional unit, operand memory, control memory and a control unit. The floating point functional unit includes a multiply accumulate function. The operand memory includes a plurality of banks of static random access memory. The processing elements are interconnected using a nearest neighbor or hierarchical implementation. The instruction set performed by the floating point functional unit includes arithmetic, control and communication instructions. The interface can be implemented as a PCI bus interface using a field programmable gate array or as an AGP bus interface.

### CROSS REFERENCE TO RELATED APPLICATIONS

This application is a continuation-in-part of PCT Patent Application No. PCT/US02/38645, filed Dec. 6, 2002, which claims the benefit of U.S. Provisional Application No. 60/338,347 filed Dec. 6, 2001. This application also claims the benefit of Provisional Patent Application No. 60/511,538 filed Oct. 15, 2003, according to the statues and rules governing provisional patent applications, particularly 35 USC § 119(e)(1) and 37 CFR §§ 1.78(a)(4) and (a)(5). The contents of the provisional patent application are specifically incorporated herein by reference.

### BACKGROUND OF THE INVENTION

The present invention is related in general to physical modeling of solid objects, and more particularly, to the use of specialized reconfigurable hardware architecture to provide acceleration for the execution of floating point intensive iterative applications.

There are a number of application areas which have characteristics like intensive floating point operations, simple but large number of iterations requiring large computational power and support for significant parallelism. These characteristics make the prospect of using special-purpose hardware to speed up the computation for such applications particularly attractive. Specialized hardware can make it easy to efficiently exploit parallelism, and given that the iterations are relatively simple, it is easy to unroll the iteration into hardware. Using a field-programmable gate array (“FPGA”) to implement the specialized hardware would be ideal, however, there are well-known efficiency problems with the FPGA implementation of floating point arithmetic.

Recently, there has been a great deal of interest in physical-based modeling from the graphics research community. In the context of graphics, physical modeling is used to simulate the behavior of objects for the purpose of animation. Physical modeling applies to a broad range of applications with highly variable requirements.

Much of the previous work in physical modeling has come from groups interested in generating animation sequences for use in the film industry. However, there are many untapped, emerging applications areas such as warfare simulation, interactive entertainment, and virtual reality. It is important to note that the requirements for these applications differ greatly. In physical modeling for film, interactivity is not required and a large number of machines could potentially be used. On the other-hand, consumer grade electronic entertainment requires interactivity and very low hardware costs.

In physical modeling of solid objects, a number of simulation techniques exist. In rigid body simulation, objects are not allowed to deform. This lack of deformation allows a great deal of pre-computation, which makes interactive simulation possible for certain scenes. However, the lack of deformation can be an important limitation. Deformable object techniques allow for the simulation of a much wider variety of materials, but have very high computational requirements.

The idea of deformable object modeling is to generate a realistic animation for an object when it deforms due to external forces. Performance of deformable object modeling tends to be very poor on general purpose CPUs. For example, chip area is not well utilized during physical modeling computations. Much of the chip area is devoted to integer computation, instruction decoding and branching. In addition, general purpose CPUs cannot dedicate all of their resources to physical modeling. The CPU must also deal with operating system overhead, input processing, sound processing, etc. A bus bottleneck also exists between the CPU and graphics hardware. Due to this performance problem, deformable object modeling has been used for off-line generation of animation sequences for movies. Deformable objects are typically modeled as a mass-spring system. Then, Hooke's Law is iteratively solved to update the simulation. Implicit integration is typically used due to stability concerns. This results in a system of equations that are then linearized. This system of linear equations can then be solved using an iterative solver such as conjugate gradient.

In addition to solid objects, there is also interest in realistic animation of fluids and gases. The computational requirements of realistic fluid dynamics are similar to deformable object modeling in that they are far too high for interactive simulation on current general-purpose processors. Typically, fluid modeling is done using three-dimensional voxels (volume elements). Navier-Stokes equations are solved in advancing the simulation. Care must be taken to ensure the simulation remains stable. Using implicit integration, this results in a large, sparse linear system to be solved on every iteration, similar to what occurs in deformable object modeling.

Ray tracing is also a very computationally intensive operation. The basic idea is to model the behavior of individual rays of light in a three dimensional scene. Since there are a very large number of rays, the application is very computationally intensive. However, parallelism can be easily exploited. Ray tracing differs from the techniques used in 3D accelerator cards in that it models light much more accurately. This lead to very realistic shadows, reflections, and lighting.

The common characteristic of all these applications are the large number of computationally intensive operations at each iteration. General purpose CPUs perform very poorly in such scenarios. Hence, such systems are incapable of providing interactive graphics processing and most of the processing needs to be done off-line. The modeling of such systems provided by 3-D accelerator cards is sometimes not realistic and is much less accurate for scientific applications.

As the above examples illustrate, there are a number of applications, especially in the domain of graphics and animation that share many important characteristics such as: (1) floating point intensive; (2) relatively simple iterations; (3) very computationally demanding; and (4) significant parallelism. Since these applications are computationally intensive (i.e., far from interactive performance on general purpose CPUs for non-trivial simulations), efficiently exploiting parallelism through the use of specialized hardware is attractive.

Rather than building an application specific integrated circuit (ASIC) for one particular algorithm, it is desirable to have a reconfigurable system that can execute many different algorithms. The main motivation behind making such a system reconfigurable is to support a wide variety of applications. For example, in the areas of graphics and image processing, different kinds of algorithms are needed for a single application, and rather than building an ASIC for only a particular algorithm, it is desirable to have a system which can be reconfigured to execute different algorithms. This would allow for a number of simulation techniques to be used. Using an FPGA to implement such specialized hardware would be ideal, since FPGAs are off-the-shelf building blocks which would make the system very cheap. Unfortunately, there have been well-known efficiency problems when using FPGAs when implementing floating point arithmetic. This is mainly a result of demand for interconnect, when aligning/normalizing.

One important development in the area of physical modeling on general-purpose hardware is the introduction of special-streaming, floating-point instructions on processors from Intel (e.g., KNI) and AMD (e.g., 3dNow!). These extensions add a number of single instruction stream, multiple data stream (SIMD) floating point instructions, allowing for additional performance when performing low-precision floating point operations. SIMD is a computer architecture that performs one operation on multiple sets of data, e.g., an array processor. However, this approach results in a rather incremental performance improvement, and compiler support remains problematic. The performance figures achieved by these systems are nowhere near those provided by fully specialized systems.

A number of new 3D graphics accelerator cards are now offering some on-board programmability. In the future, it may be possible to perform physical modeling directly on the graphics card, which would avoid bus bottlenecks, and would potentially offer higher floating point performance. However, this scheme too is unlikely to offer orders of magnitude improvement in floating point performance.

In specialized hardware for iterative floating point codes, there is little prior work. The GRAPE (Gravity Pipe) is a machine for performing N-gravity body computations that are of use to astronomers. The GRAPE project at the University of Tokyo has evolved over several generations. The current GRAPE-6 system is able to achieve a peak performance of 100 trillion floating point operations per second (TFLOPS). The Pixel Flow system developed by the University of North Carolina, Chapel Hill, is a scaleable machine for real-time advanced graphics rendering. The core idea of the Pixel Flow project is to accelerate rendering by assigning each piece of the final image to a specialized processing element.

### SUMMARY OF THE INVENTION

The present invention is directed to a specialized hardware system to accelerate physical modeling and other floating point intensive iterative applications. This acceleration allows for the simulation of complex scenes at interactive speeds.

The invention is directed to a reconfigurable computing system for floating point intensive iterative applications. In the present invention, the system is reconfigurable through software every time a different application is to be run on the system. This is unlike the usage of the term reconfigurable in prior art systems in which a generic layout of chips is configured for a specific application and is not then reconfigurable by software thereafter. The main objective of the architecture of the present invention is to achieve the highest performance at the lowest cost for iterative floating point intensive applications. Since the applications typically perform a large number of relatively simply iterations, it is possible using the system of the present invention to distribute computation to a large number of independent processing elements. Each processing element (referred to herein as PE) is complex enough to handle significant precision of floating point numbers. It requires a modest control and data memory. An efficient schedule of operations for each iteration can be determined a priori and stored locally in each processing element.

The reconfigurable computing system of the present invention includes a plurality of interconnected processing elements mounted on a custom printed circuit board (PCB), a host processing system (such as Linux) for displaying real-time outputs of the floating point calculations performed by the processing elements, and a bus interface (such as a PCI bus or AGP) for connecting the custom printed circuit board to the host system. Using a parallel interface will enable the system to provide the results to the host quickly enough to achieve real-time simulation updates.

Each of the interconnected processing elements includes a fast floating point functional unit, operand memory, control memory, a control unit, and a programmable communication interface to neighboring PEs. The system communicates with the host machine via a parallel interface. The floating point unit provides floating point add, subtract, multiply, divide/reciprocate and multiply-accumulate operations. It provides suitable checks to detect overflow/underflow exceptions for each operation. The local memory is divided into operand memory and control memory. The operand memory includes a plurality of banks of static random access memory. In one embodiment, the operand memory is in the form of four banks of 128×32 SRAM, while the control memory is one bank of 128×40 SRAM. Since the computations do not change much over successive iterations, the data can be stored on on-chip SRAM. The use of local SRAM cells provides the required amount of high speed and bandwidth, giving high memory performance for the target application. In addition, each PE contains a program counter (PC) and a communications register (COMM). Control instructions and data are downloaded into the private memories of individual PEs from the host machine. Each PE processes instructions from its own control memory and the results are communicated back to the host CPU.

In one exemplary embodiment, the processing elements are interconnected using a nearest neighbor implementation (although a hierarchical implementation can also be used). A nearest neighbor interconnections strategy provides low complexity. The instruction set performed by the floating point functional unit includes arithmetic, control and interconnect instructions. The PCI bus interface can be implemented as a FPGA. The device is not limited to a PCI (“plug-and-play”) connectivity or configuration. An Accelerated Graphics Port (AGP) interface can be used in an alternate embodiment. The alternate embodiment, based on the same principles of operation and same inventive concept allows for full compatibility with AGP standards, including AGP8x. Data transfer rate is not limited by internal architecture, but rather by the choice of PCI or AGP connectivity.

### DESCRIPTION OF THE DRAWINGS

The invention is better understood by reading the following detailed description of an exemplary embodiment in conjunction with the accompanying drawings.

FIGS. 1A-1B illustrate a diagram of a processor architecture for a prototype system.

FIG. 2 illustrates an animation sequence generated using the prototype processor architecture hardware of FIG. 1.

FIG. 3 illustrates a PCI board floor plan of an exemplary embodiment of the floating point intensive reconfigurable computer for iterative applications of the present invention.

FIG. 4 illustrates a high level overview of the system components in an exemplary embodiment of the present invention.

FIG. 5 illustrates the identification of processing elements via column and row number in accordance with an exemplary embodiment of the present invention.

FIG. 6 illustrates a diagram of a custom-integrated circuit processing element in accordance with an exemplary embodiment of the present invention.

FIG. 7 illustrates the transversal path for a control word in override mode in accordance with an exemplary embodiment of the present invention.

FIGS. 8A-8B illustrate the components of a processing element and the data flow through the processing element in accordance with an exemplary embodiment of the present invention.

FIGS. 9A-9B illustrate the design hierarchy of a VHDL representation of an exemplary embodiment of the invention.

### DETAILED DESCRIPTION OF THE INVENTION

The following description of the present invention is provided as an enabling teaching of the invention in its best, currently known embodiment. Those skilled in the relevant art will recognize that many changes can be made to the embodiment described, while still obtaining the beneficial results of the present invention. It will also be apparent that some of the desired benefits of the present invention can be obtained by selecting some of the features of the present invention without using other features. Accordingly, those who work in the art will recognize that many modifications and adaptations to the present invention are possible and may even be desirable in certain circumstances, and are a part of the present invention. Thus, the following description is provided as illustrative of the principles of the present invention and not in limitation thereof, since the scope of the present invention is defined by the claims.

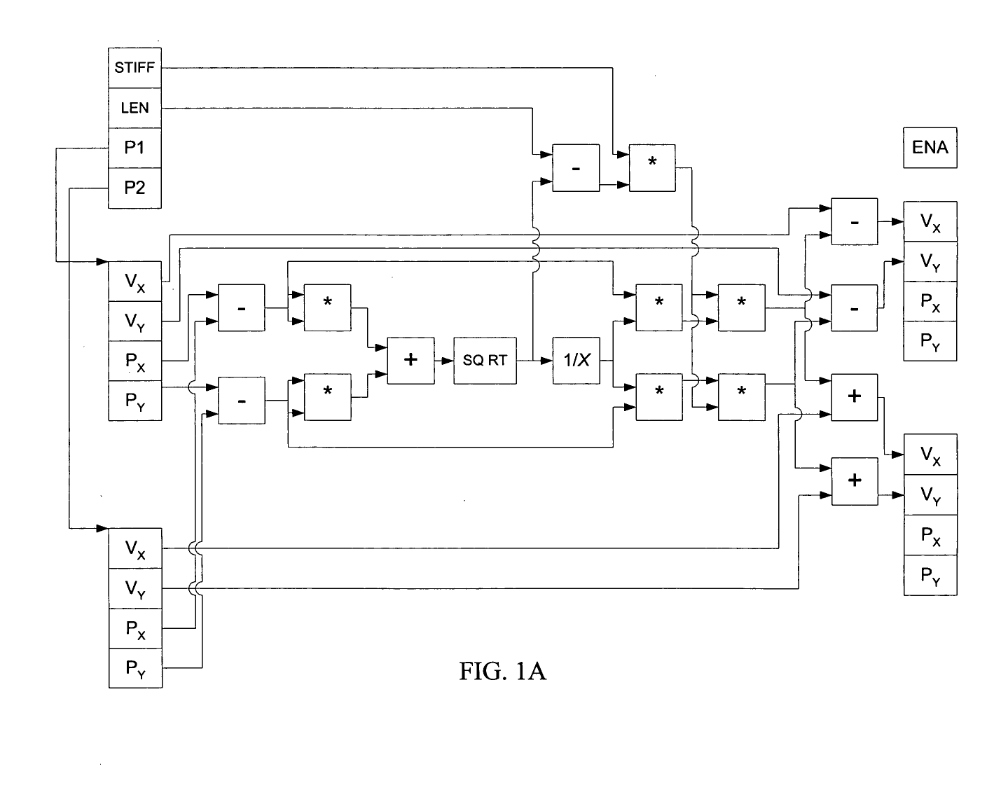

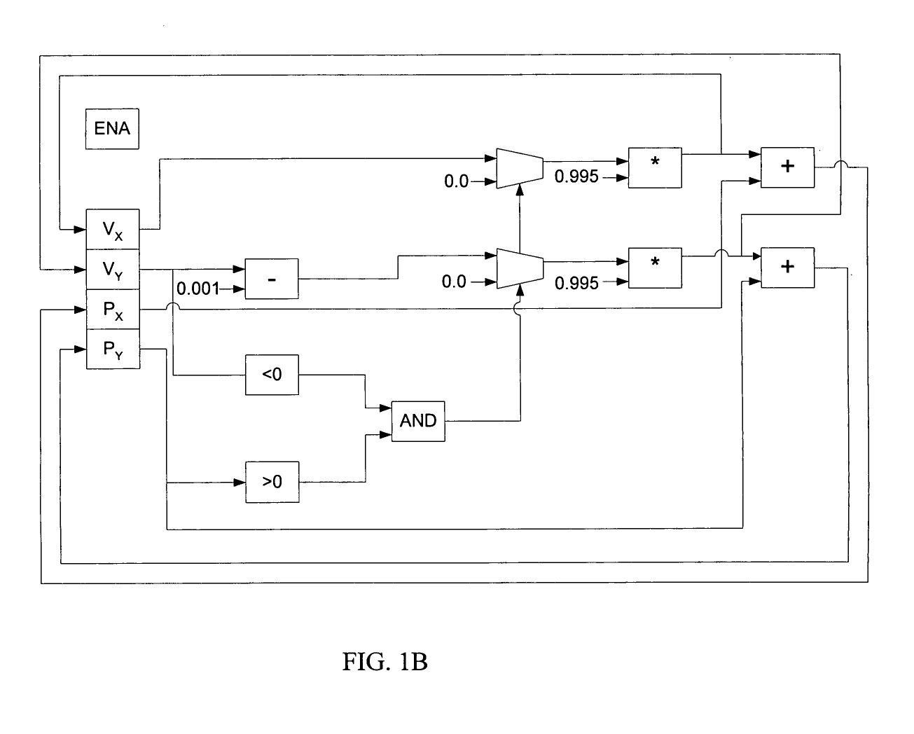

In order to show that physical modeling performance improvements are possible through the use of specialized hardware, a prototype system was first constructed to implement a mass-spring deformable object simulation. This system uses a forward Euler solver. The prototype system illustrated in FIGS. 1A-1B was implemented on a high-density Alterra EPF10K250 FPGA (250 k gates) used in conjunction with a custom circuit board and specialized memory. This field programmable gate array (FPGA) was placed on the custom-printed circuit board (PCB), which was then connected to a host machine for graphic output via a parallel cable.

The organization of the specialized processor was pipeline oriented. The idea was to take the Euler function and basically unroll it into a pipeline on the FPGA. FIGS. 1A-1B show a diagram of the solver pipeline. Table 1 below shows the number and type of functional units used in the processor.

TABLE 1

| Functional Unit | Number |
|---|---|
| Adder | 11 |
| Multiplication | 9 |
| Square Root | 1 |
| Reciprocation | 1 |
| Memory | 1 |
| Miscellaneous | 5 |

The biggest problem with the prototype system was utilization of the FPGA. This was a result of the well-known problems in implementing floating point arithmetic in programmable logic. An FPGA-based implementation makes it very difficult to implement barrel shifters due to FPGA routing problems. This leads to high area and low performance for normalization/alignment steps in floating point operations. In addition, it is impossible to implement the full collision detection/resolution and spring force calculation pipeline in hardware due to area constraints on the FPGA.

In order to compress the design so that it would fit on the FPGA, a number of simplifications were necessary. These simplifications included a removal of pipeline registers, two-dimensional simulation, reduced floating point precision (the mantissa was reduced), and simple collision detection. The final FPGA utilization was 79%.

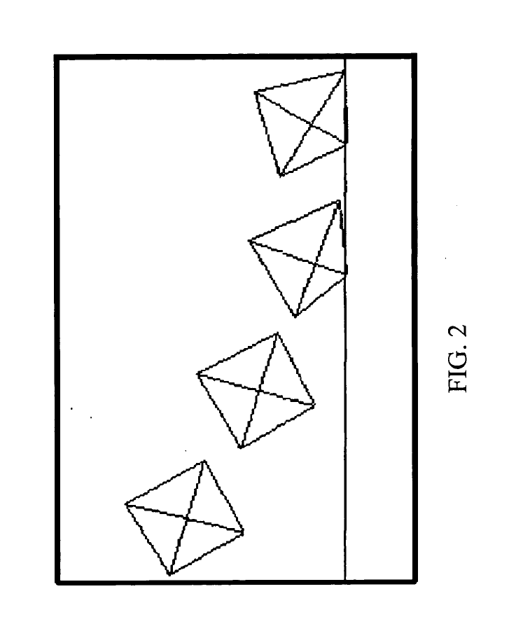

After the simplifications were made, the prototype project was completed and successfully tested. FIG. 2 shows an animation sequence that was generated on the hardware system. The performance of this system can be examined in comparison to existing general-purpose machines. For the 2D simulation above, a Pentium II/300 MHz machine can achieve 0.32M iterations per second. Assuming pipelining and 300 MHz operations, the prototype system could achieve 30M iterations per second. This represents a 92× speedup over the general-purpose machine. This would be even higher for 3D simulation, since the pipeline can exploit greater parallelism.

The lessons learned on the construction of the developmental prototype system were applied in designing the present invention. The most important distinctions are that the present invention implements an implicit solver (stability in forward Euler is very poor) and is constructed as a custom integrated circuit (IC).

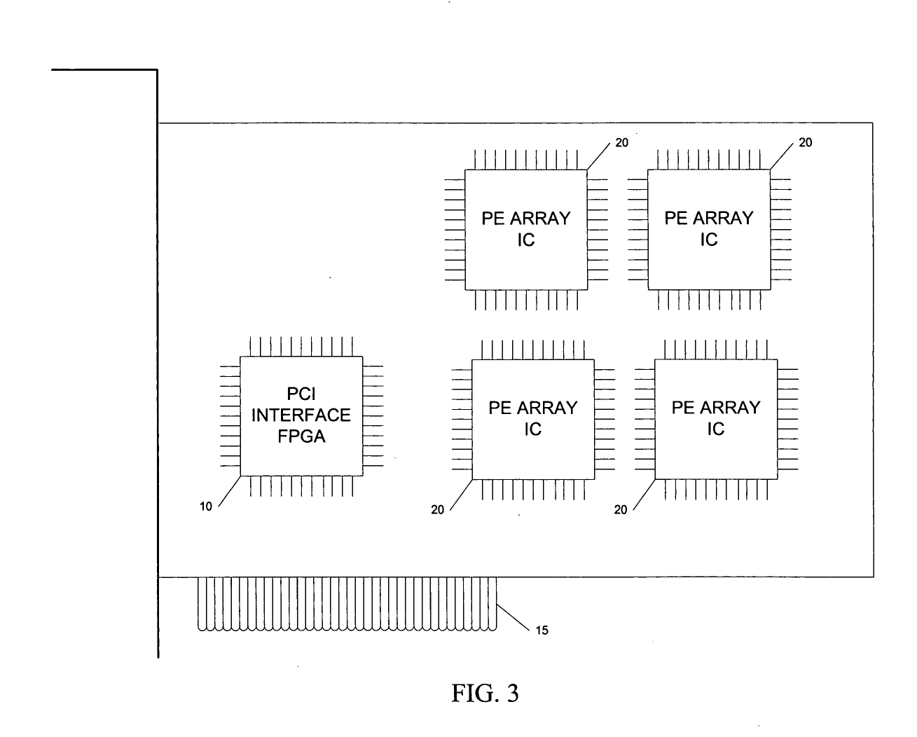

In an exemplary embodiment, the custom integrated circuits can be fabricated using Taiwan Semiconductor Manufacturing Corp. (TSMC) design technology available through MOSIS. MOSIS is a non-profit microelectronics broker providing low-cost prototyping and small-volume production service for VLSI circuit development. Several of these custom integrated chips populate a custom printed circuit board. The custom printed circuit board is connected to a LINUX host system through a Peripheral Component Interconnect (PCI) bus 15 (FIG. 3). The bus interface can be implemented as an FPGA using a PCI core. The PCI bus interface increases the design complexity, but it is necessary in order to supply simulation results to the host quickly enough to achieve real-time display updates. FIG. 3 shows a diagram of the printed circuit board organization using a PCI bus interface implemented as an FPGA. It depicts the FPGA PCI interface 10 and four processing element array integrated circuits 20.

An AGP interface can also be used in an alternate exemplary embodiment. A very important feature of the AGP is direct memory execute (DIME). The DIME gives AGP chips the capability to access main memory directly for complex mapping operations. AGP is a dedicated connection that can only be used by the graphics subsystem.

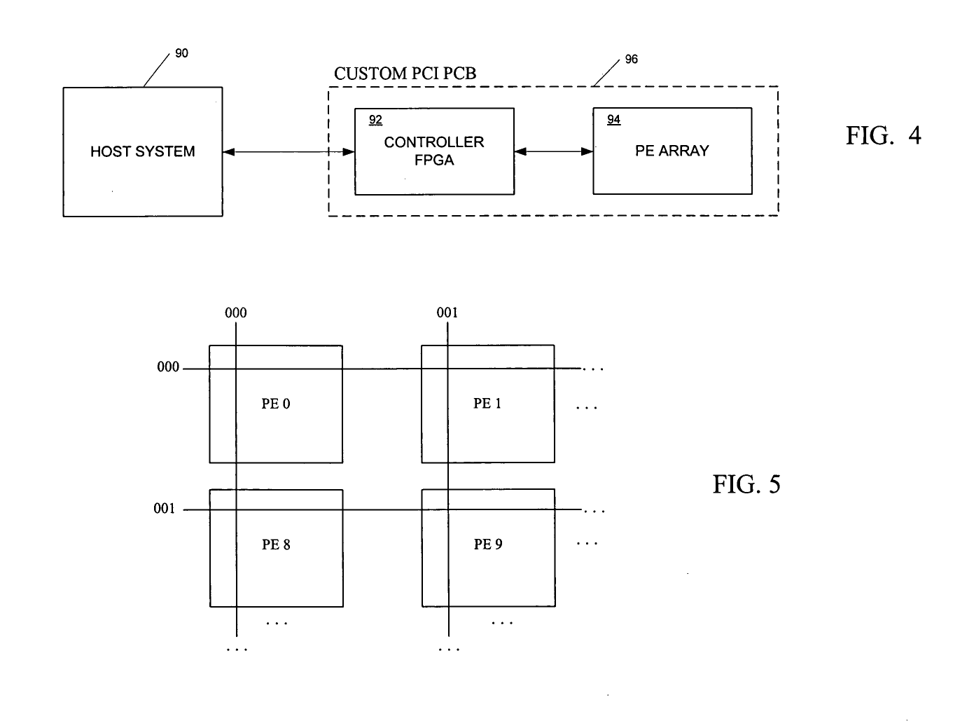

A high level overview of the reconfigurable computing system of the present invention is illustrated in FIG. 4. The system includes a known-good host system 90, a controller FPGA 92 and the custom PE array 94 on a custom printed circuit board 96. The system has only two global signals: clock and PC-enable. PEs 20 identify themselves by column and row, as illustrated in FIG. 5. A simple locking circuit is used to prevent two adjacent PEs from performing interconnect stores to each other simultaneously, possibly burning out transistors. All that is required is to ensure that no two adjacent PEs are executing store instructions simultaneously. If this condition occurs, the write buffers of the PEs are disabled and a flag is set. At the end of program execution, the flag is examined. If it is clear, then all went well. If it is set, a simulator is used to determine precisely where the program faltered. It is possible to perform a more specific check within the array hardware itself, but this would unnecessarily increase the complexity of the PE array.

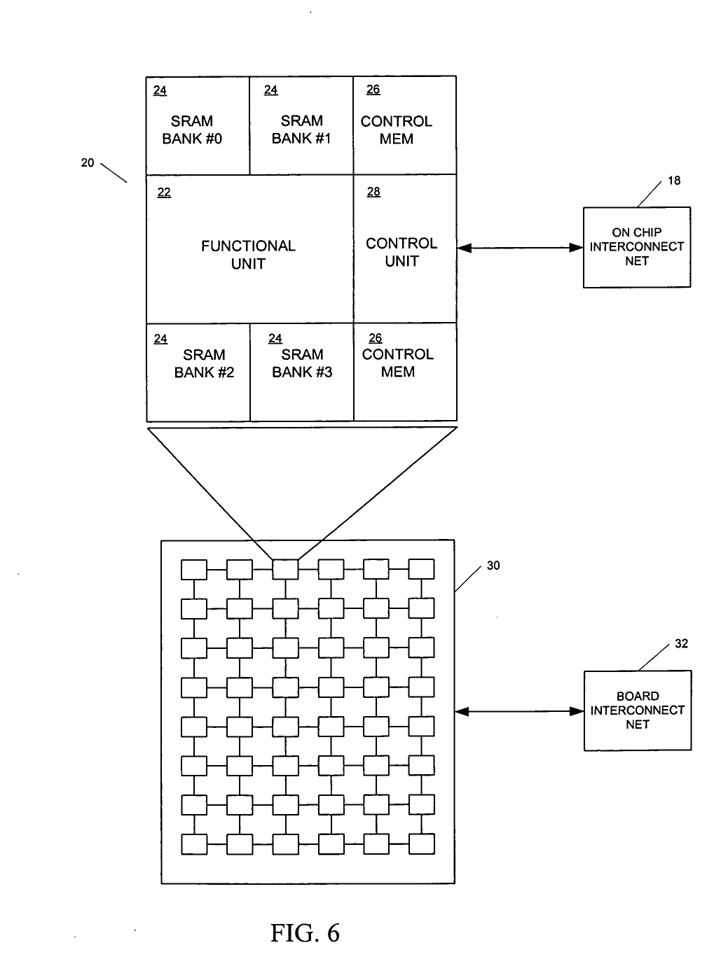

As shown in FIG. 6, each processing element 20 includes a floating point functional unit 22, operand memory 24, control memory 26, and a simple control unit 28 on one integrated circuit (i.e., a single chip). The floating point functional unit also includes a multiply accumulate (MAC) function. Although there is also a divide/reciprocation function as well, simulations show that the divide operation is rare.

In each processing element 20, there is local static random access memory (SRAM) 24 for operand and control storage. Distributing a large amount of high speed, high bandwidth SRAM such as this offers very high memory performance for the target operation. In order to achieve optimal performance, the operand storage should contain four banks 24 of 128 32-bit words. The four banks allow for operation in the form A*B+C [symbol] D. The control memory 26 is a separate storage and relatively small in comparison (128×40 SRAM). The maximum instruction length is 40 bits. The size of on-board RAM is not critical for performance. The device can function faster by replacing the type of RAM used (from SIMM to DIMM) at the same size of on-board memory. SIMM and DIMM are acronyms for single in-line memory module and dual in-line memory module, respectively. They are small circuit boards that can hold a group of memory chips. The bus from the SIMM to the actual memory chips is 32 bits wide. DIMM provides a 64-bit bus.

Since most of the processing element area is consumed by memory, memory cell area is of critical importance. Dynamic random access memory (DRAM) offers considerable advantages in this regard. Static RAMs do not require refresh circuitry as do dynamic RAMs, but they do take up more space and require more power. However, for the initial implementation of the invention, SRAM was chosen for robustness. Specifically, SRAM was chosen because of the concern about noise effecting sensing on the memory bitlines.

Since computation is distributed over a number of processing elements 20, efficient communication is very important. At the board level 30, interconnect 32 is more limited than within the IC. A large number of 32-bit busses will cause packaging difficulties, increasing chip-to-chip delay due to routing congestion, and will increase power dissipated in the chip I/O pads.

Within the IC 20, the interconnect method 18 can be more flexible. The primary concern is to allow for efficient communication without significantly increasing area overhead. Delay is not expected to be a problem in the present invention since the operand bitlines have a higher capacitive load. The main interconnect options for this invention are a nearest neighbor style and a hierarchical approach.

Using a nearest neighbor interconnect strategy, the processing elements 20 can be efficiently connected to their cardinal neighbors (north, south, east, west). This results in a simple and regular layout as illustrated in FIG. 6. In a nearest neighbor interconnect strategy, a number of options exist for treating boundaries (torus, wrap, etc.), however, in this design, wiring complexity can be reduced by not allowing on-chip boundary communication. The position of each PE is hard-coded in terms of its (X, Y) coordinates and every PE is identified by its coordinates.

A hierarchical or tree-based approach offers the advantage of faster communication between distant neighbors. This interconnection method is commonly used in modern FPGAs. Hierarchical communication tends to be necessary when the number of processing elements are large, as in modern FPGA-based systems which are fine-grained in terms of the logic blocks used. In the present invention, a hierarchical interconnect approach leads to an unnecessary wiring overhead.

In each method, a processing element 20 must be allowed to quickly broadcast its data to all other processing elements. This rules out a one-dimensional interconnection method. However, broadcasts can be formed over multiple cycles by rippling through a nearest neighbor network, for example.

One additional interconnection problem is making sure that interconnect is not being driven by separate processing elements. This problem can be addressed by host-side software checking prior to execution. However, hardware locking is preferable and is discussed more fully below.

Clock distribution is also an important consideration. The primary concern is to minimize the probability of a system crippling design error. Since phase-locked loop (PLL) design is a fairly complex and error-prone process, it may be safer to combine two or more out-of-phase board level clock signals in the IC.

The PE supports a novel I/O scheme for loading the PE with programs and data and retrieving results from the PE array. Therefore, every PE operates in two modes: I/O mode or override mode and compute mode. In the override mode, instructions and data are downloaded to the PE from the host machine. In the compute mode, the PEs execute the instructions in their control memories. A global PC-enable signal controls the mode of operation (i.e., is used to switch between modes). The PE is in compute mode if PC-enable=1 and is in the override mode when PC-enable=0. Thus, every PE has two different instruction classes for each mode. The instruction format and instruction sets for both compute mode and override mode are provided in greater detail below.

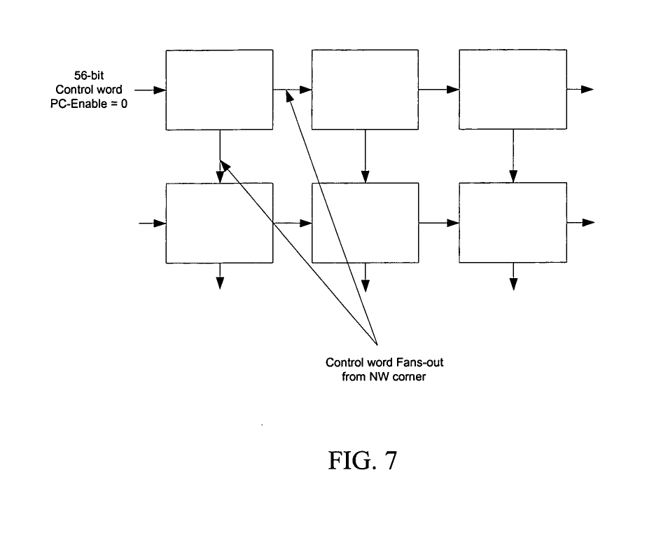

In the override mode, while loading the PEs, each PE receives a 56-bit control word from its north and west neighbors, possibly modifies the word, and passes it on to its south and east neighbors. The PE forms a single 56-bit word, called the Override Word or OvrWrd, by bitwise OR-ing the words received from its north and west neighbors. Therefore, I/O commands fan-out in a 2-dimensional wave, starting from the northwest corner of the array, towards the southeast corner. FIG. 7 illustrates the traversal path for a control word in override mode. This is accomplished by using the “PUT” command to write to the control memory (program), operand memory (data) or the program counter (PC). To read data from the PE array, a “LOOK-UP” instruction is sent to the northwest corner PE. This command fans out through the array. Every PE receiving this command compares its coordinates with the PE field of the instruction. If there is no match, then the instruction is simply passed on. If there is a match, then the PE performs the indicated SRAM (operand or control) read and inserts the results into a Result Response, which propagates through the array and eventually appears at the southeast corner from where it can be read.

This scheme dramatically reduces the number of pins required for the chip. The entire array thus depends on only two global signals, i.e., PC-enable and clock.

In the compute mode, each PE starts execution by reading the instruction pointed to by the program counter. These include arithmetic, control and communication instructions. In the arithmetic class, the instruction set provides for ADD, SUB, MULT and DIV, which are two operand instructions, and MAC, which is a three operand instruction. The arithmetic class also provides NOP, which is a zero operand instruction. Each operand field independently specifies an operand SRAM bank (2 bits) and a location within the bank (7 bits). Control class instructions include conditional branching which is provided by the BLZ instruction, which loads the new program counter value if the value stored at the location pointed to by R1 is less than zero.

Interconnect class instructions deal with the COMM register. The LOAD instruction enables the PE to read from the COMM register of any of its four neighbors. The LOAD instruction reads data off the COMM register of the specified PE, while a STORE instruction, cause a PE to write to its own COMM register. The LOAD instruction uses the DIR field (north, south, east, or west) to load the given operand location from the given direction. The STORE instruction is used by a PE to place data into the COMM register for its neighbors to read. The STORE instruction uses the DIR field to enable its write buffers in the given direction and reads its data from the given operand location. The design allows every instruction to access an operand SRAM bank only once. This removes the need for any additional decode logic for operand memory access and allows all instructions to be completed in a single clock cycle.

Processing Element Cell Design

As discussed above, the array of processing elements has two modes: compute and override. In compute mode each PE executes an instruction stream as defined by its control memory and program counter (referred to herein as PC). In override mode, the override instructions are streamed through the array from the upper-left-hand corner (PE 0, 0) toward the lower-right-hand corner (PE (n−1), (n−1)). In override mode, each PE forms its next override word by a bit-wise OR operation on the override messages received from its neighbors to the north and west. Simultaneously, it transmits its current override word to its neighbors to the south and east.

The override instructions are used for array I/O. The current array mode is determined by a global PC-enable signal. When PC-enable is 1, the array is in compute mode. Otherwise, it is in override mode. Unconnected communication input lines on the edges of the array are tied to ground.

Each PE has four SRAM banks for the operand memory; each bank contains 128 32-bit words. Each PE's control memory is a single bank of 128 40-bit words. No instruction may use an operand bank more than once (each bank has a single read and a single write port).

Each PE contains a 32-bit floating point unit which is capable of performing floating point add, subtract, multiply, divide and multiply-and-accumulate (MAC) operations.

The compute mode instruction format is provided in Table 2. Operands are specified with a two-dimensional address. The operand format is provided in Table 3. Therefore, the compute mode instruction is a 40-bit word which specifies the opcode and the banks and the offsets of each operand. Again, note that no instruction may use an operand bank more than once, hence R1, R2, R3, R4 each point to a different operand memory bank.

TABLE 2

| Field | Opcode | R1 | R2 | R3 | R4 |
|---|---|---|---|---|---|
| Length (bits) | 4 | 9 | 9 | 9 | 9 |

TABLE 3

| Field | Bank | Offset |
|---|---|---|
| Length (bits) | 2 | 7 |

The compute mode instructions are shown in Tables 4-7. Arithmetic instructions are provided in Table 4. Control instructions are provided in Table 5. If the word stored in R1 is negative, then the PC is loaded with the value stored in the seven rightmost bits of R4. PE-PE communication instructions must specify a direction as well as a command. Adjacent PEs may read each other's COMM register during the same clock cycle. This allows for full-duplex communication. Nearest neighbor compass direction encodings are provided in Table 6. The direction is stored in the two right-most bits of R1. The instructions for communication between processing element are provided in Table 7.

TABLE 4

| Opcode | Mnemonic | Operation |
|---|---|---|
| 0000 | NOP | No operation |
| 0001 | ADD R1, R2, R4 | RI + R2 -> R4 |
| 0010 | SUB R1, R2, R4 | R1 − R2 -> R4 |
| 0011 | MULT R1, R2, R4 | R1 * R2 -> R4 |
| 0100 | MAC R1, R2, R3, R4 | R1 * R2 + R3 -> R4 |
| 0101 | DIV R1, R2, R4 | R1/R2 -> R4 |

### EXAMPLES

ADD 0, 02, 7 1, 19

MAC 0, 12 3, 44 1, 101 2, 98

TABLE 5

| Opcode | Mnemonic | Operation |
|---|---|---|
| 0110 | BLZ R1, PC | If (R1 < 0.0) R4[6..0] -> PC |

### EXAMPLES

BLZ 3,4 34

BLZ 2,23 0x37

TABLE 6

| Direction | Encoding |
|---|---|
| WEST | 00 |
| EAST | 01 |
| SOUTH | 10 |
| NORTH | 11 |

TABLE 7

| Opcode | Mnemonic | Operation |
|---|---|---|
| 0111 | LOAD DIR, R4 | NEIGHBOR (R1[1..0]).COMM -> R4, |
| | | where NEIGHBOR is either west, east, |
| | | south, or north depending upon DIR. |
| 1000 | STORE R1 | R1 -> COMM, value in R1 is stored in the |
| | | COMM register. |

### EXAMPLES

LOAD EAST 0, 0
STORE 3, 6

The override mode instruction format is provided in Table 8. The format of the Location field is provided in Table 9. The X-Coordinate increases to the east; the Y-Coordinate increases to the south. The memory banks (accessed by bank and offset) are defined in Table 10.

TABLE 8

| Field | Opcode | Location | Value |
|---|---|---|---|
| Length (bits) | 2 | 14 | 40 |

TABLE 9

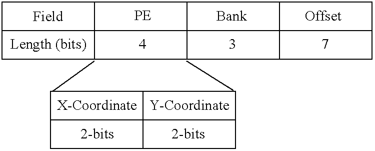

TABLE 10

| Bank(s) | Usage |
|---|---|
| 000-011 | Operand memories (0-3) |
| 100 | Control Memory |
| 111 | Program Counter |

The override mode instruction set is provided in Table 11. Put instructions targeting an operand memory must right-align the 32-bit datum within the 40-bit VAL field. PEs responding to a lookup instruction reading an operand memory must also right-align the 32-bit datum. Furthermore, as the PEs perform single precision floating point arithmetic, decimal values stored to operand memories will be stored as single precision floating point values. Hexadecimal values will be stored to operand memories without conversion. Only unsigned hexadecimal values should be used.

TABLE 11

| Opcode | Mnemonic | Operation |
|---|---|---|
| 00 | NOP | No operation |
| 01 | LOOKUP PE, LOC | Lookup value of location in the |
| | | processing element PE. The PE for |
| | | which this instruction is intended will |
| | | change the opcode to 11 (3) to |
| | | indicate that the lookup value |
| | | has been found. |
| 10 | PUT PE, LOC, VAL | Store the value “VAL” in the |
| | | processing element PE at location LOC |
| 11 | FOUNDIT PE, LOC | Refer lookup opcode |

### EXAMPLES

| | |
|---|---|
| PUT 0, 0 4, 0 “STORE 0, 0” | # Store an instruction. |
| PUT 0, 0 0, 0 “0x5555” | # Store to operand memory. |
| PUT 2, 2 3, 127 “−10” | #Store to operand memory. |
| PUT 2, 2 3, 127 “120.35” | #Store in operand memory. |
| PUT 2, 2 3, 127 “345E−6” | #Store in operand memory. |
| PUT 0, 0 7, 0 “0” | #Reset PC |
| LOOKUP 1, 0 0, 0 | #Read from operand memory. |

Control Signals and Fields

Before describing the data flow diagram for a processing element, the external inputs, internal control signals and the fields of any processing element are provided below. The values of the control signals depend upon the mode of operation of the system. In the override mode, the values depend upon the OvrWrd received from the north and west neighbors while in the compute mode, the control signal values are determined by the control word (CMWrd) read from the local control memory. The fields for the overword (override mode) are identified in Table 12. Overword[55..O] is obtained by “OR”-ing overwords from west and north neighbors. The fields for control memory word are identified in Table 13. The control memory word is a 40-bit word read from control memory.

TABLE 12

| | |
|---|---|
| OWD[39..0] | 40-bit Data field |
| OWC.Op[55..54] | 2 bit Override Mode Opcode |
| OWC.PE[53..50] | PE Co-ordinates |
| OWC.Bank[49..47] | Bank (000-011, 100, 111) |
| OWC.Addr[46..40] | Offset |

TABLE 13

| | |
|---|---|
| CM.Op[39..36] | 4-bit Opcode |
| CM.R1Bank[35..34] | R1 - Bank |
| CM.R1Addr[33..27] | R1 - Address |
| CM.R2Bank[26..25] | R2 - Bank |
| CM.R2Addr[24..18] | R2 - Address |
| CM.R3Bank[17..16] | R3 - Bank |
| CM.R3Addr[15..9] | R3 - Address |
| CM.R4Bank[8..7] | R4 - Bank |
| CM.R4Addr[6..0] | R4 - Address |

The control signal values are determined using these fields. The signal equations are represented in pseudo-code. The various control signals can be classified as external I/O signals, status signals, operand memory signals, control memory signals, functional unit signals and program counter signals.

External I/O Signals

The external I/O signals provide the interface for connection to other PEs and to the host interconnect for the boundary PEs. The various external I/O signals are:

| | |
|---|---|
| XCoord [1:0] | X-Coordinate of PE |
| YCoord [1:0] | Y-Coordinate of PE |
| Clk | global clock signal |
| PCEnable | signal to switch between override and compute modes |
| WS_n | Write Strobe |

Status Signals

The status signals are asserted or de-asserted to indicate the status of certain operations. These signals include PE-Hit, Unique, and WriteBack. PE-Hit is asserted to indicate an exact match between the X and Y co-ordinate values received in the OvrWrd with the own co-ordinates of the PE. The PE-Hit is used to disable all the other operations if the received OvrWrd is not meant for the current PE (PE-Hit=0). The Unique signal provides a sanity check of operand memory bank accesses by any CMWrd during the compute mode. Specifically, this signal disables multiple operand memory bank accesses by the same instruction. This policy has been enforced to maintain simplicity so that all instructions can be completed in one clock cycle. The WriteBack signal is de-asserted during a read operation when the memory bank drives its output bus. It is de-asserted for a memory write when the bus is driven by an external source.

PEHit=1 in the Override mode if XCoord and YCoord refer to the co-ordinates of the current PE. PEHit=(!(PCEnable)&&(OWC.PE==((XCoord<<2)∥YCoord))).

The Unique signal provides a sanity check to ensure that an instruction accesses an operand memory bank only once.

```
Unique = CM.Op == 7
    || !( CM.R1Bank == CM.R2Bank
    || CM.R1Bank == CM.RSBank && CM.Op == 4
    || CM.R1Bank == CM.R4Bank
    || CM.R2Bank == CM.R3Bank && CM.Op == 4
    || CM.R2Bank == CM.R4Bank
    || CM.R3Bank == CM.R4Bank && CM.Op == 4).
```

WriteBack signal is used to enable the tri-state buffers which allow the result to be written back into an operand memory bank. When WriteBack=1, memory stops driving the output bus and the buffers drive the bus to write the data into the memory bank.

WriteBack=( CM.Op>0 &&CM.Op<6
|| CM.Op == 7).

Operand and Control Memory Signals

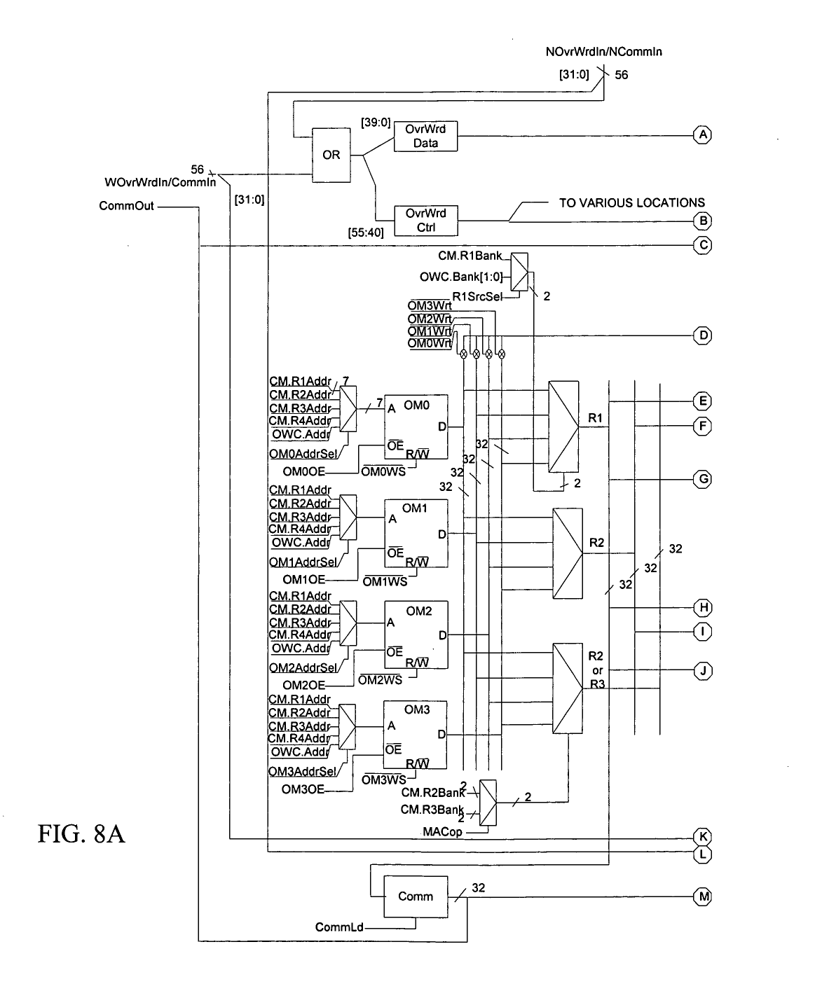

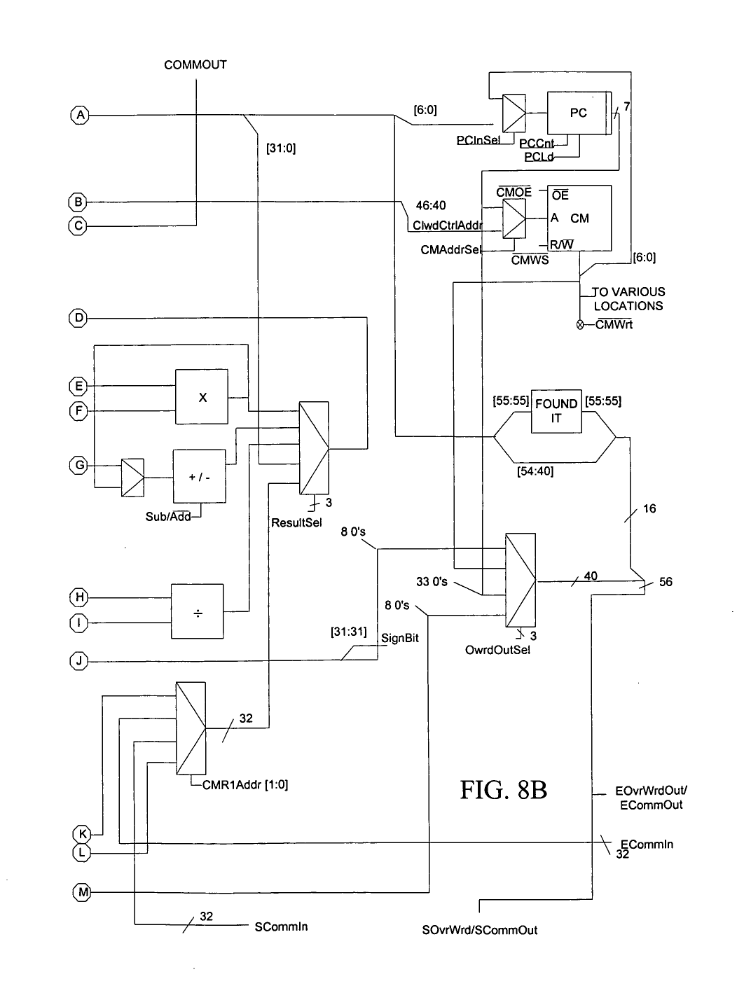

From the datapath design of FIGS. 8A-8B, the operand and control memory interface consists of the Address Select (AddrSel). Output Enable (OE_n), Write Enable (Wrt_n) and the Chip Enable (CE_n) control signals. The CE_n signal is an active low signal used to enable/disable a particular memory bank. It is asserted (CE_n=0) at all times for both operand and control memories during the compute mode. In the override mode, however, the CE_n signal is asserted for the particular banks only if there is a write instruction to the bank. When CE_n is de-asserted, the memory bank ignores any transition on its input lines and maintains its output bus at tri-state. The OE_n signal is used to control the direction of the internal output line drivers in the memory units. The OE_n signal is asserted (OE_n=0) for all read operations when the memory drives the output bus and it is de-asserted during a write operation when the output bus is driven by an external source. The Write-Enable (Wrt_n) signal is used to distinguish between a read and a write operation to the memory bank. On assertion, (Wrt_n=0), a write operation is performed and a read operation is performed when it is de-asserted.

Table 14 provides the calculation of these signals in the override and commute modes. In Table 14, the entity “x” refers to the particular bank being addressed in the calculation. “x” can take on the values 0, 1, 2, and 3 in the exemplary embodiment. OM refers to the operand memory banks and CM refers to the control memory bank. For example OmxCE_n refers to the calculation of the CE_n signal for the operand memory specified by “x”.

OMxAddrSel is used as a select line for the multiplexer which selects the address for the bank x. OMxOE_n is the active low output enable signal for bank x. it is deasserted during a write operation in compute mode and for a “PUT” instruction in override mode (which is again a write). OmxWrt_n is the active low write enable signal for bank x. It is active for an operand memory bank write during override mode (“PUT” instruction) or compute mode (writing result back to R4). In all other cases it is de-asserted. OmxWS_n is the write strobe which is controlled by the global write strobe (WS_n). The write will be executed only when write strobe is asserted. OmxWS_n=WS_n∥OmxWrt_n. OmxCE_n is the active low chip enable signal for bank x. It is active at all times in the compute mode. In the override mode it is asserted for a “PUT” or “LOOKUP” instruction which accesses bank x.

TABLE 14

| SIGNAL | LOGIC | DESCRIPTION |
|---|---|---|
| OMxCE_n | if (PCEnable=1) then 0 | CE_n signal is asserted at all times |
| | elsif (!PCEnable && | in the compute mode. It is asserted |
| | OvrWrd.Bank=x) then | in the override mode if there is a |
| | 0 | write command to the bank |
| | else 1 | specified by x. |
| CMCE_n | if (PCEnable=1) then 0 | CE_n signal for the control |
| | elsif (!PCEnable && | memory bank is asserted at all |
| | PE-Hit && | times in the compute mode. It is |
| | OvrWrd.Op == 2 && | asserted if there is a write |
| | OvrWrd.Bank ==4) | command to the control memory in |
| | then 0 | the override mode. |
| | else 1 | |
| OmxOE_n | if (PCEnable && | OE_n signal is de-asserted for an |
| | CM.R4Bank==x) then | operand memory write. It is |
| | 1 | asserted at all other times. |
| | elsif (!PCEnable && | |
| | OvrWrd.Op==2) then | |
| | 0 | |
| | else 1 | |
| CMOE_n | !PCEnable && | OE_n is de-asserted on a write to |
| | Ovr.Wrd.Op == 2 | the control memory during |
| | | override mode. It is asserted at all |
| | | times during the compute mode |
| | | (when there are no writes to the |
| | | control memory) |
| OmxWrt_n | if (Unique&& Write-Back | Wrt_n is asserted for an operand |
| | && PCEnable && | memory write during compute and |
| | CM.R4Bank == x) | override mode. It is de-asserted at |
| | then 0 | all other times. |
| | elsif (!PCEnable && PE- | |
| | Hit && OvrWrd.Op | |
| | == 2 && | |
| | OvrWrd.Bank == x) then 0 | |
| | else 1 | |
| CMWrt_n | !(!PCEnable && PE-Hit && | Wrt_n for control memory is |
| | OvrWrd.Op == 2 && | asserted only in the override mode. |
| | OvrWrd.Bank == 4) | |
| OmxAddrSel | if (!PCEnable) then 4 | AddrSel is the control signal for |
| | elsif (CM.R1Bank == X) then 0 | the external mux to select the |
| | elsif (CM.R2Bank == X) then 1 | proper read/write address for any |
| | elsif (CM.R3Bank == X) then 2 | operand memory bank. It is |
| | else 3 | calculated by the value of ‘x’. |
| CMAddrSel | !PCEnable | In override mode, the control |
| | | memory address is obtained from |
| | | the OvrWrd while in the compute |
| | | mode, it is obtained from the |
| | | Program Counter (PC). |

Functional Unit Signals

The functional unit signals are used to control the operation to be performed and to determine the final result depending upon the operation. The details of these signals are provided in Table 15.

TABLE 15

| SIGNAL | LOGIC | DESCRIPTION |
|---|---|---|
| MACOp | CM.Op == 4 | Control signal to select |
| | | between the MULT and MAC |
| | | operations |
| Sub/Add_n | CM.Op == 2 | Control signal to select |
| | | between the ADD and SUB |
| | | operations. This bit is input to |
| | | the FPADDSUB unit as initial |
| | | CARRYIN bit. |
| SignBit | R1[31:31] | Sign bit of the data stored at |
| | | R1. Used in the BLZ |
| | | instruction to make a |
| | | branching decision. |
| R1SrcSel | !PCEnable | Used to select the correct |
| | | address to access the R1 bank |
| | | in override and control modes. |
| ResultSet1[2..0] | if (!PCEnable) then 011 | Control signal for selecting the |
| | elsif (MC.Op == 3) then 00 | correct output depending upon |
| | elsif (Mc.Op == ∥CM.Op | the operation denoted by |
| | == 2 ∥ CM.Op == 4) then | CM.Op. All functional units |
| | 001 | much on the input data, hence |
| | elsif (CM.Op == 5) then 010 | result has to be selected from |
| | else 100 | the correct functional unit. |

Miscellaneous Control Signals

Other miscellaneous control signals are used to control the program counter (PC) and the communication and output units. Specifically, the PC uses three signals: PCInSel to select the correct input address to the PC, PCLd which loads the PC with a new address when it is asserted and PCCnt which causes an automatic increment of the address in the PC when it is asserted. Care is taken to ensure that PCCnt and PCLd are not asserted at the same time. These signals, their logic and operation are detailed in Table 16.

OWrdOutSel acts as the select line to select the final result. This is combined with the control information to form the output Ovrword.

OWC[55:55] is the “FOUNDIT” signal (refer to instruction set) which changes the opcode to 11 when the value is found.

TABLE 16

| SIGNAL | LOGIC | DESCRIPTION |
|---|---|---|
| PCInSel | !(PCEnable) | Controls input address to the PC. |
| | | In oerride mode, PC address is |
| | | obtained from the OvrWrd. The |
| | | PC can be overwritten by a |
| | | successful jump in the compute |
| | | mode. |
| PCLd | (PCEnable && Cm.Op == 6 && | When this signal is asserted, the |
| | SignBit) ∥ (PCEnable && PE- | contents of the PC are |
| | Hit && OvrWrd.Op == 2 && | overwritten. This happens during |
| | OvrWrd.Bank == 7) | PC initialization in the override |
| | | mode and due to a successful |
| | | jump in the compute mode. |
| PCCnt | PCEnable && (!PCLd) | This is the increment signal of the |
| | | PC which asserted every cycle in |
| | | the compute mode if PCLd is de- |
| | | asserted. |
| CommLd | PCEnable && CM.Op == 8 | This is the enable signal for the |
| | | Communication Register. It is |
| | | asserted in the compute mode for |
| | | a “STORE” instruction. |
| OWC[55:55] | (PE-Hit && OvrWrd.Op == 1 | This signal is known as the |
| | && (OvrWrd.Bank < 5 ∥ | “FOUNDIT” signal. This signal is |
| | OvrWrd.Bank == 7)) ∥ | asserted on a successful look-up |
| | OWC[55:55] | instruction in the override mode. |
| OwrdOutSel | if (PCEnable) then 100 | This signal is used to select the |
| | elsif (PE-Hit && OvrWrd.Op == | lower 40-bits of the final output |
| | 1 && OvrWrd.Bank < 4) | OvrWrd of the PE. |
| | then 001 | |
| | elsif (PE-Hit && OvrWrd.Op == | |
| | 1 && OvrWrd.Bank == 4) | |
| | then 010 | |
| | elsif (PE-Hit && OvrWrd.Op == | |
| | 1 && OvrWrd.Bank == 4) | |
| | then 011 | |
| | else 000 | |

Data Flow Description

FIGS. 8A-8B illustrate the components of a processing element and the data flow through the processing element. The inputs to each PE are:
Clk—the global clock signal;
PCEnable—control bit to switch between override and compute modes;
XCoord, YCoord—(X, Y) co-ordinates of the PE (hard-coded for every PE);
WOvrWrdIn/CommIn—OvrWrd (56-bits) from west neighbor;
NOvrWrdIn/CommIn—OvrWrd (56-bits) from north neighbor;
SCommIn—CommWord (32-bits) from south neighbor;
ECommIn—CommWord (32-bits) from east neighbor;

The outputs of each PE are:
OvrWrd—56-bit OvrWrd to east and south neighbors;
CommOut—32-bit CommWord to west and north neighbors;
Every PE receives OvrWrds from its north and west neighbors, processes the OvrWrd and provides OvrWrd output to its east and south neighbor. The Comm output from each PE goes to all of its neighbors. Consequently, every PE's COMM register can be read by any of its neighbors.

The following general comments apply to the dataflow diagram of FIGS. 8A-8B:
A signal which is written as SIGNAL_n denotes an active low signal.

The global signals Clk, PCEnable, XCoord and YCoord are not shown connected to any component to keep FIGS. 8A-8B as simple as possible. In the VHDL derived from the dataflow diagram, Clk is connected to every sequential component and PCEnable is connected to every component. The XCoord and YCoord signals are connected to a logic block which is used to identify the PE.
Some inputs/outputs for the peripheral PEs which are not used are connected to the ground. For example, for the PEs in the rightmost rows, there is no east neighbor, hence their EOvrWrdOut/ECommOut lines are connected to ground.

The components of the PE are shown in the data flow diagram of FIGS. 8A-8B. The PE is divided into different blocks: the OvrWrd Block, which consists of the 56-bit OvrWrd register that stores the computed OvrWrd (OvrWrd is computed by the bitwise OR-ing of the OvrWrds received from the north and west neighbors); the PC Block, which includes the PC and its supporting control logic; the CM block which includes the control memory, the Functional Unit, that includes the operand memory banks and the FPU; and the Output Block that includes the output selector logic.

OvrWrd Block—The OvrWrd block includes an OR gate and the OvrWrd register. The input WOvrWrd and NOvrWrd are ORed and the result acts as the OvrWrd for the current PE. This is stored in the OvrWrd register after splitting it into its components. The upper 16 bits of the OvrWrd (i.e., bits 55 to 40) are labeled as OvrWrdCtrl and the lower 40 bits (bits 39 to 0) are labeled as OvrWrdData. OvrWrdCtrl specifies the opcode and bank for the PE and OvrWrdData is the data or value used in that instruction.

PC Block—This includes the program counter (PC) and the supporting logic for reading, writing and incrementing the PC. In override mode, the PCInSel=1, PCCnt=0 and PCLd=0, so that PC gets loaded with the lower 7 bits of the OvrWrdData. In compute mode, the PC is automatically incremented after every instruction to point to the next instruction in the control memory. The PC is rewritten with a new value when a branch instruction causes the control to be branched to a different address.

CM Block—The control memory (CM) block includes a single 128×40 SRAM bank and supporting logic to read and write to the memory. In override mode, CMAddrSel=1, CMWS_n=0, CMOE_n=1, CMWrt_n=0. Hence the OvrWrdData is written in the CM at the address pointed to by OwdCtrlAddr. In compute mode, CMWS_n=1, CMOE_n=0, CMWrt_n=1, CMAddrSel=0. Hence the data pointed to by the address in the PC is read from the CM. The CM is such that when CMWS_n (CM write strobe) and CMWrt_n (CM write) are low and CMOE_n (CM output enable) is high, data is written into the CM. When CMWS_n=CMWrt_n=1 and CMOE_n=0, data is read from the CM.

Functional Unit—This includes the 32-bit floating point unit with MAC support, 4 banks of 128×32 operand memories and a Result multiplexer to select the correct result to be written back to the memory.

Output Block—This includes the “Found-It” logic and the output multiplexer. The “Found-It” logic operates in the override mode and sets the MSB of the OvrWrd to 1 if a look-up instruction is successful. The output multiplexer is used to select the correct output from the functional unit.

The data flow is described herein by considering a representative instruction from both the override and compute modes.

Override Mode: PUT 1, 0 4, 0<instruction>

This instruction is used to write the value <instruction> into the CM. The logical flow of steps for this instruction is as follows:
OvrWrdBlock—Assume the above instruction is available as WOvrWrdIn/CommIn and NOvrWrdIn/CommIn=0. A bitwise OR operation of the words from the north and west neighbors is performed and OvrWrdCtrl and OvrdWrdData are obtained. Hence OvrWrdCtrl=PUT 1,0 4,0 and OvrWrdData=<instruction>.
PC Block—In override mode, PCInSel=0, so input to the PC is OvrWrdData[6..0]. The PC is viewed as bank 7. Since this is a write to bank 4, PCLd=0 and the data is ignored by the PC.
CM Block—This instruction performs a write to the control memory (bank 4). Therefore, CMAddrSel=1, CMOE_n=1, CMWS_n=0, CMWrt_n=0. The value <instruction> gets written to the CM at the address given by OwdCtrlAddr (which in this case is 0).
Functional Block—Since this instruction does not concern any of the operand memory blocks, OMxAddrSel=0, OMxOE=1, OMxWrt_n=1, OMxWS_n=1, where x=0, 1, 2 or 3. None of the operand memory blocks is affected in any way. Also, in override mode, PCEnable=0, so the floating point unit and result multiplexer are disabled. If this were a write to any operand memory bank, then the OMxWS_n and OMxWrt_n signals for the corresponding bank will be asserted and OMxOE_n will be deasserted.
Output Block—In override mode, the PE does not compute anything but just passes on the received data to its east and south neighbors. Hence, OwrdOutSel=0.

Compute Mode: MAC R1, R2, R3, R4 where R1=0,0 R2=1,7 R3=2,12 R4=3,5

This instruction calculates R1*R2+R3 and places the result into R4. The bank and addresses pointed to by each of R1, R2, R3 and R4 are as described above. The logical flow of steps for this instruction is as follows:
OvrWrd Block—Since PE is in compute mode, OvrWrd block is disabled.
PC Block—Assume this instruction is written at address 0 in the CM. Hence the PC output is (0000000)_{b}. PCCnt=1, so that PC is auto-incremented to point to the next instruction.
CM Block—In compute mode, CMAddrSel=0 so that address given to CM is the PC output. CMOE_n=0, CMWrt_n=1, CMWs_n=1. Hence the instruction is read from the address (0000000)_{b} of the CM. It is then decoded to give values of CM.Op (the opcode), CM.R1Bank, CM.R1Addr, CM.R3Bank, CM.R2Addr, CM.R3Bank, CM.R3Addr, and CM.R4Bank, CM.R4Addr.
Functional Unit
   The operands are first read from the banks 0, 1 and 2. Hence OMOAddrSel=0 (since R1=0,0), OM1AddrSel=2 (since R2=1,7), OM2AddrSel=3 (since R3=2,12) and OM3AddrSel=4 (since R4=3,5).
   For banks 0, 1, 2 OMxOE_n=0, OMxWS_n=1, OMxWrt_n=1; for bank 3 OM3OE_n=1, OMxWrt_n=0, OMxWS_n=0. The outputs of the operand memory banks are denoted as follows: OM0 as D0, OM1 as D1 and OM2 as D2.
   In compute mode, R1SrcSel=0, so output of that multiplexer is CM.R1Bank (i.e., 0) and consequently, output of the R1-multiplexer is D0. Similarly, output of the R2-multiplexer is D1.
   Since this is a MAC instruction, MACOp=1, so output of the bottom multiplexer is CM.R3Bank. Consequently, the output of the R2 or R3-multiplexer (i.e., R2 or R3) is D2. Thus all the operands to execute the instruction are determined.
   R1 and R2 are provided as inputs to the multiplier block and the inputs to the add/subtract block are the output of the multiplexer and R2 or R3.
   For MAC operation, ResultSel=1, so that output of the add/subtract block is selected as the result to be written back.
      During write-back, OM3Wrt_n=0, OM3WS_n=0, OM3OE_n=1 so that the result is written into OM3.
Output Block—In compute mode, OwrdOutSel=4, so that output of the COMM register is appended to OvrWrdCtrl and given as output to east and south neighbors.

The load and store instructions are slightly different. The store instruction stores the data pointed by the R1 field to the COMM register. Hence, after the data from the bank pointed by R1 is read, CommLd=1 so that the COMM register is loaded with this data and then OwrdOutSel=4, so that this data can be read by any of this PE's neighbors.

For the load instruction, the lower 2 bits of the data pointed by the R1 field denote the direction of the neighbor from which the current PE reads the data. 00 denotes west, 01 denotes east, 10 is south and 11 denotes north. Hence CM.R1Addr[1..0] causes the multiplexer to select the data from the correct neighbor and this data is then written back to the address given by the R4 field.

All the operations are completed in a single clock cycle. The worst case execution time for a single PE was determined by the floating point divide unit. In the described implementation, the minimum clock period to complete all operations was found to be 110 ns or a clock rate of 9.1 MHz. Since all four PEs perform operations in parallel, total speed of the system is 36.4 MHz. Since each PE performs exactly one FLOP per clock cycle, a floating point performance of 36 MFLOPS is obtained. Clearly, this speed will increase as more PEs are accommodated on the die.

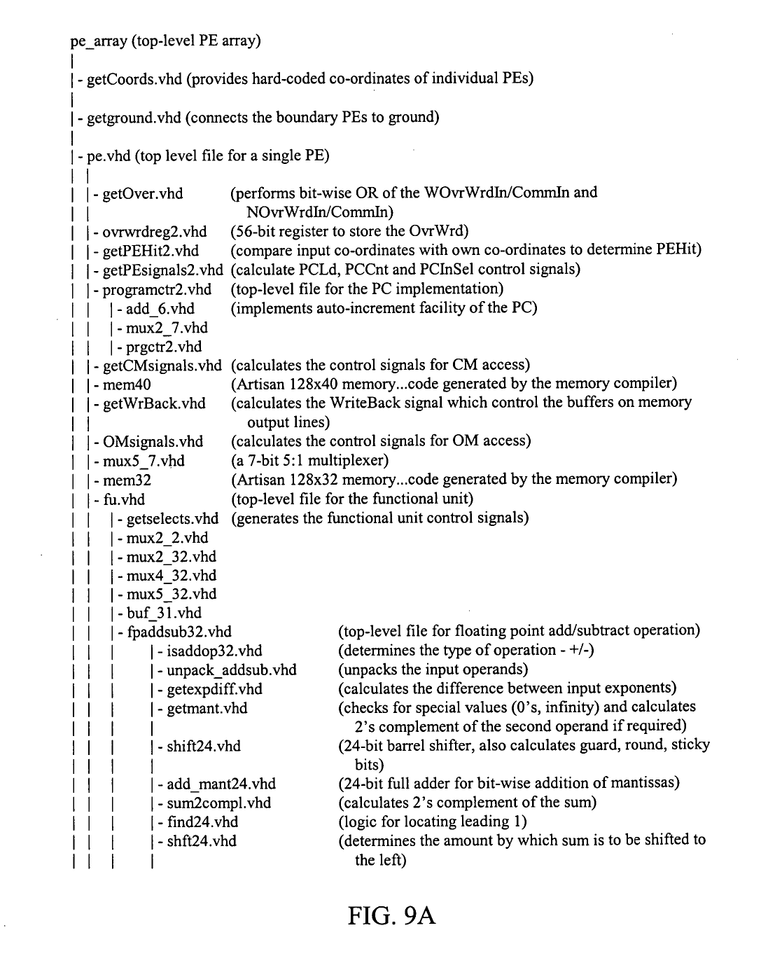

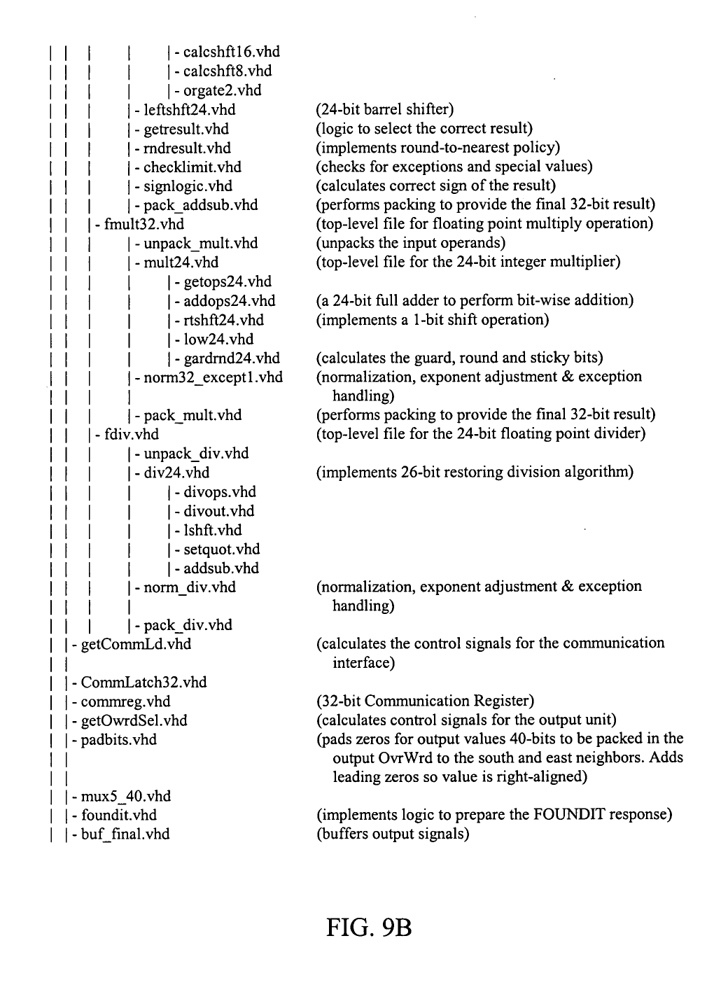

The entire custom integrated circuit can be represented using VHDL. FIGS. 9A-9B illustrate the design hierarchy of the VHDL representation. Care was taken to include only those constructs from the VHDL language which can be easily and correctly synthesized by the synthesis tool. A bad VHDL representation often leaves to a bad and sometimes oversized netlist.

A top down design methodology for the VLSI design is based on computer-aided synthesis of gate-level netlist using a behavioral or structural VHDL description. The functionality of the system is specified using a VHDL or Verilog description and computer aided design programs, which are used to obtain a generic gate-level netlist. The netlist is then mapped to a standard cell library, which includes the basic building blocks and is usually provided by vendors. This methodology is well-suited for digital designs with short time-to-market and moderate area performance requirements. The VHDL code can be developed on a Sun Ultra Sparc-10 machine running Solaris. It can be compiled and simulated using the Cadence and NC VHDL compiler and NC-SIM simulator from the Cadence Tool Suite. The design hierarchy shown in FIGS. 9A-9B provides the functionality of each VHDL unit in brief. This diagram highlights the modular design strategy used. Information about the various commands to be used can be readily found using the Cadence documentation.

The TSMC 0.18 μm technology, standard cell libraries for logic, IO and the SRAM memory provided by Artisan, Inc. under the MOSIS Educational Program were used to implement an exemplary embodiment.

Automatic logic synthesis of the VHDL representation and its mapping to the TSMC 0.18 μm technology was accomplished using Ambit BuildGates. The VHDL representation is first converted into a generic netlist which is then mapped to the target technology, namely TSMC 0.18 μm. BuildGates performs this mapping using the library information from the cell library and user-defined timing, area, and power constraints. The output of this stage is a technology-specific netlist represented in either Verilog or in the Design Exchange Format (DEF).

Placement and routing involves floorplanning of the die area and the placement and routing of the standard cells and macro blocks. This can be implemented using the Silicon Ensemble-Physically Knowledgeable Synthesis (SE-PKS) platform within the Cadence tool suite. SE was also used for clock tree generation, power connections and timing analysis of the design. The primary input for this state is the synthesized netlist in Verilog or DEF format.

A generic netlist is generated using the do_build_generic command. Upon execution of this command, BuildGates generates a control/data flow graph to analyze the input design, determine the number of latches, and flip-flops to store data, determine the sizes and types of components required to implement the logic and generate the appropriate control and interconnect logic.

The generic netlist is mapped to the target technology using the do_optimize optimization command. This mapping step includes several intermediate steps that are known as transformations. Transformations are commands that change the structure of a logic block. The optimization command repeatedly performs these transformations, depending upon a global cost function, which is set by the various user-defined constraints and by the technology-specific data. When the optimization command is executed, several optimizations, like logic optimization, structural optimization, clock tree optimization, and timing optimization are performed. These optimizations may involve dissolving the hierarchy in the generic netlist for efficient mapping to technology-specific cells, adding buffers to maintain signal integrity, adding buffers and drivers to propagate the clock signal, reclaiming area freed during optimization, fixing multi-port nets, performing timing corrections to remove hold and setup time violations and fixing any design rule violations. The output of the optimization step is an efficient technology-specific netlist subject to certain user-defined and technology-specific constraints.

In the exemplary embodiment described herein, each PE array includes only 4 PEs. This is because the embodiment was constrained to a 7.5 sq. mm. area by MOSIS. In a production system, the number of PEs in a single PE array will be limited by the available area, overall latency, power consumption, and the speed-up requirement. Theoretically, any number of PEs can be put in a single PE array, but practically, this would be limited. A better, denser design allows more PEs in a single PE array for a given area.

Different PE arrays are on different chips, however, the design of the array is such that multiple chips can be connected in a manner to get a bigger PE array. For example, four 4×4 PE array chips can be arranged to get an 8×8 PE array. Therefore, different chips each having PE arrays can be combined to get greater speed up. This capability is unique, because even with FPGAs, the overhead of connecting different “FPGA chips” is pretty high. In the present invention, the PE array chips can be seamlessly connected without any need to modify the application running on them.

The present invention attempts to pack as much computation into as small a space as possible. This computational density should lead to a higher level of switching activity than what is seen in general-purpose processors. Therefore, power consumption and heat generation may become problematic. For example, heat generation can constrain the clock rate. It may be possible to apply a number of techniques in order to reduce the effects of high switching activity. These techniques include heat tolerant packaging, low-swing interconnect, and possibly scheduling operations in order to reduce switching activity.

Those skilled in the art will appreciate that many modifications to the exemplary embodiments of the present invention are possible without departing from the spirit and scope of the invention. In addition, it is possible to use some of the features of the present invention without the corresponding use of the other features. Accordingly, the foregoing description of the exemplary embodiments is provided for the purpose of illustrating the principles of the present invention and not in limitation thereof since the scope of the present invention is defined solely by the appended claims.

1. A reconfigurable computing system for accelerating execution of floating point intensive iterative applications, comprising:
a plurality of interconnected processing elements forming an array placed on an integrated circuit, each processing element including a floating point functional unit, operand memory, control memory and a control unit and reconfigurable by a program instruction for each floating point intensive iterative application;
a host processing system for displaying real-time outputs of the floating point intensive iterative applications; and
an interface for connecting the plurality of interconnected processing elements to the host processing system.

2. The reconfigurable computing system for accelerating execution of floating point intensive iterative applications of claim 1 wherein the floating point functional unit includes a multiply accumulate (MAC) function.

3. The reconfigurable computing system for accelerating execution of floating point intensive iterative applications of claim 1 wherein the operand memory comprises a plurality of banks of static random access memory.

4. The reconfigurable computing system for accelerating execution of floating point intensive iterative applications of claim 1 wherein the operand memory comprises dynamic random access memory.

5. The reconfigurable computing system for accelerating execution of floating point intensive iterative applications of claim 1 wherein the operand memory comprises four banks of static random access memory.

6. The reconfigurable computing system for accelerating execution of floating point intensive iterative applications of claim 1 wherein the control memory comprises a bank of random access memory.

7. The reconfigurable computing system for accelerating execution of floating point intensive iterative applications of claim 1 wherein the plurality of processing elements forming an array are interconnected using a nearest neighbor implementation in which each processing element is connected to its cardinal neighbor processing elements.

8. The reconfigurable computing system for accelerating execution of floating point intensive iterative applications of claim 1 wherein the plurality of processing elements are interconnected using a hierarchical implementation.

9. The reconfigurable computing system for accelerating execution of floating point intensive iterative applications of claim 1 wherein each processing element executes a plurality of classes of program instructions.

10. The reconfigurable computing system for accelerating execution of floating point intensive iterative applications of claim 1 wherein each processing element has both a compute mode and an override mode of operation.

11. The reconfigurable computing system for accelerating execution of floating point intensive iterative applications of claim 10 wherein the mode of operation for the plurality of processing elements is determined by a global signal.

12. The reconfigurable computing system for accelerating execution of floating point intensive iterative applications of claim 10 wherein each processing element in compute mode executes a program instruction stream as defined by a program counter and a control memory.

13. The reconfigurable computing system for accelerating execution of floating point intensive iterative applications of claim 10 wherein each processing element in override mode forms an override word by a logical OR operation of control words received from a pair of cardinal neighbor processing elements.

14. The reconfigurable computing system for accelerating execution of floating point intensive iterative applications of claim 12 wherein the compute mode instructions include arithmetic, control and communication instructions.

15. The reconfigurable computing system for accelerating execution of floating point intensive iterative applications of claim 14 wherein the arithmetic instructions include a no operation instruction, an add instruction, a subtract instruction, a multiply instruction, a divide instruction and a multiply accumulate instruction.

16. The reconfigurable computing system for accelerating execution of floating point intensive iterative applications of claim 14 wherein the control instructions include a conditional branch instruction.

17. The reconfigurable computing system for accelerating execution of floating point intensive iterative applications of claim 14 wherein the communication instructions include a load instruction and a store instruction.

18. The reconfigurable computing system for accelerating execution of floating point intensive iterative applications of claim 13 wherein the override mode instructions include a put instruction, a lookup instruction and a found instruction.

19. The reconfigurable computing system for accelerating execution of floating point intensive iterative applications of claim 18 wherein the put instruction stores to a control memory, an operand memory or a program counter.

20. The reconfigurable computing system for accelerating execution of floating point intensive iterative applications of claim 18 wherein the lookup instruction reads from an operand memory.

21. The reconfigurable computing system for accelerating execution of floating point intensive iterative applications of claim 18 wherein the found instruction sets the most significant bit of an override word if a lookup instruction is successful.

22. The reconfigurable computing system for accelerating execution of floating point intensive iterative applications of claim 1 wherein the interface is implemented using a field programmable gate array (FPGA).

23. The reconfigurable computing system for accelerating execution of floating point intensive iterative applications of claim 1 wherein the interface is a Peripheral Component Interconnect (PCI) bus interface.

24. The reconfigurable computing system for accelerating execution of floating point intensive iterative applications of claim 1 wherein the interface is an Accelerated Graphics Port (AGP) interface.

25. A processing element for use in an array of processing elements placed on an integrated circuit and forming a reconfigurable computing system to accelerate the execution of computationally intensive instructions, wherein the array of processing elements is reconfigurable by a program instruction for each computationally intensive application comprising:
a functional component for performing a plurality of floating point instructions;
a plurality of operand banks for providing inputs to and writing outputs from the functional component;
a control memory for providing and storing instructions that control operation of the processing element; and
an output component for providing an output signal to an adjacent processing element.

26. The processing element for use in an array of processing elements of claim 25 further comprising a program counter for pointing to an instruction in control memory that is to be executed by the functional unit.

27. The processing element for use in an array of processing elements of claim 25 further comprising an input register for storing an instruction determined from a logical combination of inputs from a pair of adjacent processing elements.

28. The processing element for use in an array of processing elements of claim 25 wherein the processing element operates in a compute mode or an override mode.

29. The processing element for use in an array of processing elements of claim 25 wherein the operand memory comprises a plurality of banks of random access memory.

30. The processing element for use in an array of processing elements of claim 25 wherein the control memory comprises a bank of random access memory.

31. The processing element for use in an array of processing elements of claim 25 wherein the array of processing elements on the integrated circuit are interconnected using a nearest neighbor implementation in which each processing element is connected to its cardinal neighbor processing elements.

32. The processing element for use in an array of processing elements of claim 28 wherein the mode of operation for the processing element is determined by a global signal.

33. The processing element for use in an array of processing elements of claim 28 wherein the processing element in compute mode executes an instruction stream as defined by the program counter and the control memory.

34. The processing element for use in an array of processing elements of claim 28 wherein the processing element in override mode forms an override word by a logical operation on control words received from a pair of cardinal neighbor processing elements.

35. The processing element for use in an array of processing elements of claim 33 wherein the compute mode instructions include arithmetic, control and communication instructions.

36. The processing element for use in an array of processing elements of claim 35 wherein the arithmetic instructions include a no operation instruction, an add instruction, a subtract instruction, a multiply instruction, a divide instruction and a multiply accumulate instruction.

37. The processing element for use in an array of processing elements of claim 35 wherein the control instructions include a conditional branch instruction.

38. The processing element for use in an array of processing elements of claim 35 wherein the communication instructions include a load instruction and a store instruction.

39. The processing element for use in an array of processing elements of claim 34 wherein the override mode instructions include a put instruction, a lookup instruction and a found instruction.

40. The processing element for use in an array of processing elements of claim 39 wherein the put instruction stores to a control memory, an operand memory or a program counter.

41. The processing element for use in an array of processing elements of claim 39 wherein the lookup instruction reads from an operand memory.

42. The processing element for use in an array of processing elements of claim 39 wherein the found instruction sets the most significant bit of an override word if a lookup instruction is successful.
